(19) United States
(12) Patent Application Publication
(10) Pub. No.: US 2024/0297694 A1
(43) Pub. Date: Sep. 5, 2024

(54) CAPABILITY INFORMATION REPORTING METHOD, APPARATUS AND DEVICE, CAPABILITY INFORMATION RECEIVING METHOD, APPARATUS AND DEVICE, AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/689,788

(22) PCT Filed: Sep. 10, 2021
(86) PCT No.: PCT/CN2021/117695

§ 371 Date: Mar. 6, 2024

(51) Int. Cl. H04B 7/06; H04B 7/08

(52) U.S. Cl. CPC H04B 7/061; H04B 7/0805

(57) ABSTRACT

A capability information reporting method includes: reporting, by a terminal, antenna switching capability information to a network device. The antenna switching capability information indicates a supporting capability of the terminal for switching between antennas or antenna ports.

### CROSS-REFERENCE TO RELATED APPLICATION

This application is the U.S. national phase application of International Application No. PCT/CN2021/117695, filed on Sep. 10, 2021, the disclosure of which is incorporated herein by reference in its entirety for all purposes.

### TECHNICAL FIELD

The present disclosure relates to the communication field, and in particular to a capability information reporting method, apparatus and device, a capability information receiving method, apparatus and device, and a storage medium.

### BACKGROUND

In a New Radio (NR) system, a terminal need to switch its antennas or antenna ports to adapt to a current service or scenario, thereby meeting transmission requirements.

The antennas or antenna ports of the terminal are generally configured in accordance with its bandwidth part (BWP). In related technologies, the implementation of an antenna or antenna port switching has to follow a change of additional information. In general, it acts through radio resource control (RRC) reconfiguration or through BWP switching.

### SUMMARY

According to one aspect of the present disclosure, a capability information reporting method is provided, including: reporting, by a terminal, antenna switching capability information to a network device; wherein the antenna switching capability information indicates a supporting capability of the terminal for switching between antennas or antenna ports.

According to one aspect of the present disclosure, a capability information receiving method is provided, including: receiving, by a network device, antenna switching capability information reported by a terminal; wherein the antenna switching capability information indicates a supporting capability of the terminal for switching between antennas or antenna ports.

According to one aspect of the present disclosure, a terminal is provided, including one or more processors, and one or more memories that store at least one piece of program code, wherein the program code is loaded and executed by the one or more processors to implement: reporting antenna switching capability information to a network device; wherein the antenna switching capability information indicates a supporting capability of the terminal for switching between antennas or antenna ports.

### BRIEF DESCRIPTION OF THE DRAWINGS

The drawings related to the description of the examples will be briefly introduced to explain the technical solutions provided by examples of the present disclosure more clearly. It is obvious that, the drawings in the following description illustrate only some examples of the present disclosure, and based on these drawings, those of ordinary skill in the art may obtain other drawings without creative work.

FIG. 1 is a schematic diagram of a slot structure according to an example of the present disclosure.

FIG. 2 is a schematic diagram of a mobile communication system according to an example of the present disclosure.

FIG. 3 is a flowchart of a capability information transmission method according to an example of the present disclosure.

FIG. 4 is a flowchart of a capability information transmission method according to an example of the present disclosure.

FIG. 5 is a flowchart of a capability information transmission method according to an example of the present disclosure.

FIG. 6 is a flowchart of a capability information transmission method according to an example of the present disclosure.

FIG. 7 is a flowchart of a capability information transmission method according to an example of the present disclosure.

FIG. 8 is a flowchart of a capability information transmission method according to an example of the present disclosure.

FIG. 9 is a schematic structure diagram of a capability information reporting apparatus according to an example of the present disclosure.

FIG. 10 is a schematic structure diagram of a capability information receiving apparatus according to an example of the present disclosure.

FIG. 11 is a block diagram of a communication device according to an example of the present disclosure.

### DETAILED DESCRIPTION OF THE EMBODIMENTS

In order to make the purpose, technical solutions and advantages of the present disclosure clearer, the implementations of the present disclosure will be further described in detail below in conjunction with the accompanying drawings.

Before introducing the technical solutions of the present disclosure, the related knowledge of the present disclosure is first described below.

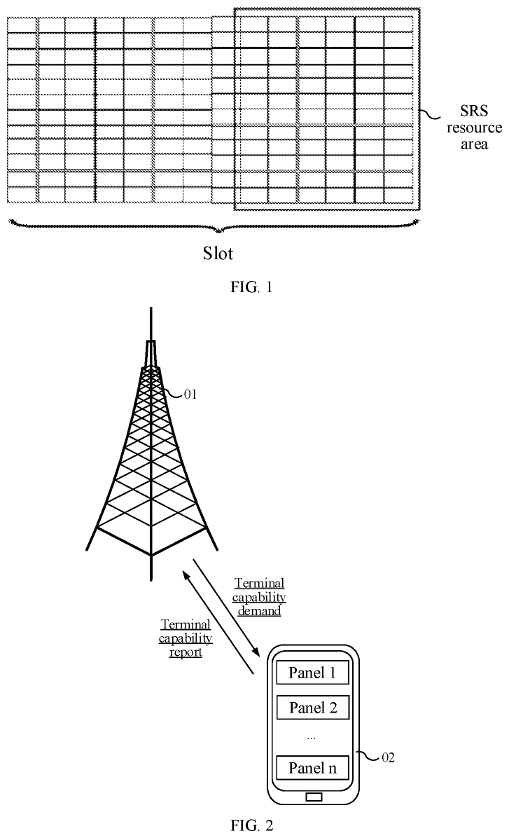

In a 5G New Radio (NR) system, uplink sounding reference signal (SRS) may be periodic SRS, semi-persistent SRS or aperiodic SRS, may be for narrow band or wideband, and may be for single-port or multi-port. Uplink SRS parameters are configured for a terminal by a network device. The configuration information includes at least one of the following information: port number, frequency domain resource location, time domain resource location, sequence, or sequence cycle offset. In the 5G NR system, as illustrated in FIG. 1, SRS is mapped on at most six symbols of one uplink slot.

Illustratively, the network device configures a plurality of uplink SRS sets for the terminal, with one resource set including one or more SRS resources. One SRS resource may locate on N consecutive orthogonal frequency division multiplexing (OFDM) symbols, where N may employ 1, 2, or 4 symbols.

### Antenna Switching

In the NR system, the network device side is supported to obtain downlink channel information based on channel reciprocity to improve downlink data transmission performance. In order to achieve that the network device can effectively obtain the downlink information based on the channel reciprocity under transceiver capabilities of different terminals, the SRS is introduced to provide reference for the network device to perform scheduling.

Illustratively, the transceiver capability of the terminal may be divided into a case where the number of transmit antennas is equal to that of receive antennas (T=R) and a case where receive antennas are more than transmit antennas (R>T). The case where the number of transmit antennas is equal to that of receive antennas includes the following situations: one transmit and one receive (1T1R), two transmit and two receive (2T2R), and four transmit and four receive (4T4R). The case where receive antennas are more than transmit antennas include the following situations: one transmit and two receive (1T2R), one transmit and four receive (1T4R), and two transmit and four receive (2T4R).

Under different antenna configurations, SRS resource configurations are also different, as follows.
For the terminal with its transmit antenna number being equal to its receive antenna number (T=R), the network device may configure at most two SRS resource sets, in which there is only one SRS resource in each set. In this case, the number of ports is equal to the number of transmit antennas of the terminal. One of the two SRS resource sets may be configured as periodic, and the other may be configured as aperiodic.
For the terminal having 1T2R capability, the network device may configure at most two SRS resource sets, in which there are two SRS resources in each set and each SRS resource has only one port.
For the terminal having 2T4R capability, the network device may configure at most two SRS resource sets, in which there are two SRS resources in each set and each SRS resource has two ports.
For the terminal with 1T4R capability, the network device configures the SRS resources according to an actual situation. At most only one resource set is configured for the periodic SRS or the semi-persistent SRS, with four SRS resources and with one port per SRS resource. At most two SRS resource sets are configured for the aperiodic SRS, in which there are a total of four SRS resources in the two SRS resource sets and these four resources are transmitted in two slots by different physical antennas. The two resource sets may be configured with each set having two resources, or be configured with one set having one resource and the other having three resources. In this case, each resource has only one port.

### Terminal Capability Reporting

According to different protocol versions, the terminal capability supported by the terminal has different definitions as follows.

The UE capabilities supported by the terminal in R15 are T1R2, T1R4, T2R4, T1R4-T2R4, T1R1, T2R2, and T4R4; and the UE capabilities supported by the terminal in R16 are T1R1-T1R2, T1R1-T1R2-T1R4, T1R1-T1R2-T2R2-T2R4, T1R1-T1R2-T2R2-T1R4-T2R4, T1R1-T2R2, T1R1-T2R2-T4R4.

In the research of R17, considering that a demand for the number of antennas of the terminal is further increased, the number of antennas may be further increased up to 6 antennas or 8 antennas. The antenna configurations supported by extended definitions are {1T6R, 1T8R, 2T6R, 2T8R, 4T6R, 4T8R}, as shown in Table 1.

TABLE 1
Antenna switching combination

| Tx\Rx | 6Rx | 8Rx |
|---|---|---|
| 1T | 1T6R | 1T8R |
| 2T | 2T6R | 2T8R |
| 4T | 4T6R | 4T8R |

Illustratively, a dynamic antenna or antenna port switching of the terminal may make reference to the following.

A dynamic transmit antenna or transmit antenna port switching (Tx switching): switching from xTyR to zTyR, with x being not equal to z and with receive antennas or receive antenna ports unchanged. For example, the terminal switches from 4T4R to 2T4R or 1T4R.

A dynamic receive antenna or receive antenna port switching (Rx switching): switching from xTyR to xTzR, with x being not equal to z and with transmit antennas or transmit antenna ports unchanged. For example, the terminal switches from 1T4R to 1T2R or 1T1R.

A dynamic switching that supports both transmit antennas and receive antennas or both transmit antenna ports and receive antenna ports (Tx/Rx switching): switching from xTyR to x′Ty'R. In this case, it is allowed that x and y are not equal to x′ and y′ at the same time, respectively. For example, the terminal switches from 4T4R to 1T2R or 1T1R.

FIG. 2 illustrates a schematic diagram of a mobile communication system according to an example of the present disclosure, including a network device 01 and a terminal 02.

In a wireless communication system, the information transmission between the network device 01 and the terminal 02 is required to be coordinated according to the terminal capability (UE capability).

When demanding the terminal 02 report its terminal capability, the network device 01 sends a terminal capability demand reporting instruction to the terminal 02. The terminal 02 reports its terminal capability information to the network device 01 in response to the reporting instruction.

Subsequently, the network device 01 performs network scheduling based on the reported terminal capability information, and sends a switching indication to the terminal 02 based on the scheduling result. The terminal 02 switches a bandwidth part (BWP) in accordance with the switching indication, so as to achieve an antenna or antenna port switching for the terminal 02.

Alternatively or additionally, at least one panel is provided on the terminal 02.

Making reference to the schematic diagram of the mobile communication system illustrated in FIG. 2 and the above related knowledge, the capability information reporting method and the capability information receiving method provided by the present disclosure are described in detail.

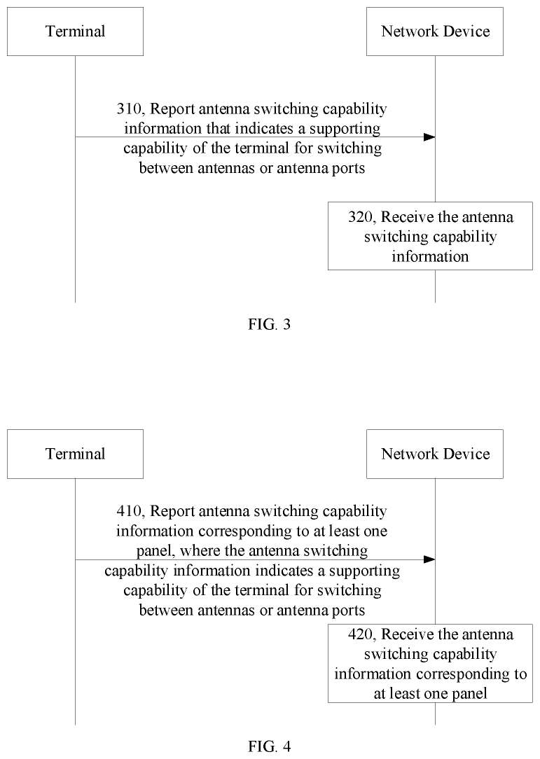

FIG. 3 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 310-320.

At step 310, the terminal reports antenna switching capability information to the network device.

Illustratively, the antenna switching capability information indicates a supporting capability of the terminal for switching between antennas or antenna ports.

The antennas refer to physical antennas of the terminal, and the antenna ports indicate logical ports used by the terminal for information transmission. Illustratively, the antenna ports may correspond to one or more physical antennas at the same time, and each antenna port represents a channel model, and using the same antenna port may be regarded as using exactly the same channel for information transmission.

According to different directions of information transmission, the antennas or antenna ports supported by the terminal include the following two types: transmit antennas or transmit antenna ports, and receive antennas or receive antenna ports. The transmit antennas or the transmit antenna ports are configured for uplink transmission, and the receive antennas or the receive antenna ports are configured for downlink transmission.

Illustratively, the supporting capability of the terminal for switching between antennas or antenna ports refers to an antenna switching configuration supported by the terminal. According to the above description, the supporting capability for switching between antennas or antenna ports includes at least one of the following.
Supporting a transmit antenna or transmit antenna port switching.

Illustratively, supporting the transmit antenna or transmit antenna port switching means that the terminal supports switching its transmit antennas or its transmit antenna ports. In this case, the receive antennas or the receive antenna ports of the terminal remain unchanged. For example, the supporting capability for switching between antennas or antenna ports includes support a transmit antenna port switching. Therefore, the network device may perform the scheduling based on the supporting capability, and send a first switching indication to the terminal. The first switching indication instructs the terminal to switch to one or more sssdesignated transmit antenna ports, with the receive antenna ports of the terminal unchanged.
Supporting a receive antenna or receive antenna port switching.

Illustratively, supporting the receive antenna or receive antenna port switching means that the terminal supports switching its receive antennas or its receive antenna ports. In this case, the transmit antennas or the transmit antenna ports of the terminal remain unchanged. For example, the supporting capability for switching between the antennas or antenna ports includes supporting a receive antenna switching. Therefore, the network device may perform the scheduling based on the supporting capability, and send a second switching indication to the terminal. The second switching indication instructs the terminal to switch to one or more designated receive antennas, with the transmit antennas of the terminal unchanged.
Supporting the transmit antenna or transmit antenna port switching and the receive antenna or receive antenna port switching.

Illustratively, supporting the transmit antenna or transmit antenna port switching and the receive antenna or receive antenna port switching means that the terminal supports switching its transmit antennas or its transmit antenna ports and switching its receive antennas or its receive antenna ports at the same time. For example, the supporting capability for switching between the antennas or antenna ports includes supporting both the transmit antenna port switching and the receive antenna port switching. Therefore, the network device may perform the scheduling based on the supporting capability, and send a third switching indication to the terminal. The third switching indication instructs the terminal to switch to one or more designated transmit antenna ports and one or more designated receive antenna ports.

Based on the above description, the antenna switching capability information indicates the supporting capability of the terminal for switching between antennas or antenna ports. In an implementation scenario example, other names that can be configured to indicate the above supporting capability may be regarded as the antenna switching capability information involved in the example of the present disclosure.

For example, the antenna switching capability information may be replaced by one of the following names: antenna switching capability item, antenna capability information, antenna capability item, antenna configuration information, antenna configuration item, antenna switching configuration information, antenna switching configuration item, switching capability information, switching capability item, switching information, switching item, switching configuration information, switching configuration item, terminal capability item, terminal switching information, terminal switching item, terminal configuration information, and terminal configuration item.

In some examples, the antenna switching capability information is carried in terminal capability information. The terminal capability information indicates a transmission capability of the terminal.

Illustratively, the terminal capability information may be identified in a form of a parameter set, including but not limited to at least one of the following parameter information: terminal category (UE Category), packet data convergence protocol (PDCP) parameters, radio link control (RLC) parameters, physical layer parameters, or radio frequency (RF) parameters. For example, the antenna switching capability information may be identified with the RF parameters.

At step 320, the network device receives the antenna switching capability information reported by the terminal.

Illustratively, the antenna switching capability information indicates the supporting capability of the terminal for switching between antennas or antenna ports.

The antennas refer to the physical antennas of the terminal, and the antenna ports indicate the logical ports used by the terminal for information transmission. Illustratively, the antenna ports may correspond to one or more physical antennas at the same time.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the antenna switching capability information is carried in the terminal capability information.

The relevant contents of the antennas or the antenna ports, the antenna switching capability information, and the terminal capability information may make reference to the above description, without being repeated here.

According to step 320, after receiving the antenna switching capability information reported by the terminal, the network device may obtain the supporting capability of the terminal for switching between antennas or antenna ports according to the information. Therefore, the network device performs a network scheduling based on the supporting capability reported by the terminal, determines the antenna or antenna port switching of the terminal, and feeds it back to the terminal to implement the antenna or antenna port switching of the terminal, thereby meeting the transmission requirements. In particular, the network device may determine the antenna or antenna port switching of the terminal based on the scheduling strategies corresponding to different transmission requirements. The scheduling strategies may be configured according to actual needs, which is not limited here.

For example, the terminal reports the antenna switching capability information to the network device. The supporting capability for switching between antennas or antenna ports indicated by the information includes supporting the transmit antenna port switching and the receive antenna port switching. The transmit antenna port(s) correspond to a first physical antenna, and the receive antenna port(s) correspond to a second physical antenna.

After receiving the antenna switching capability information, the network device may learn the above content, and then performs the network scheduling based on it. For example, the network device sends a switching indication to the terminal. The switching indication instructs the terminal to switch to the transmit antenna port(s) corresponding to the first physical antenna and switch to the receive antenna port(s) corresponding to the second physical antenna.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

In view of the above, in the capability information reporting method and the capability information receiving method provided by the example of the present disclosure, by reporting the antenna switching capability information to the network device by the terminal, the network device can schedule a terminal-level antenna switching according to the supporting capability of the terminal for switching between antennas or antenna ports.

FIG. 4 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 410-420.

At step 410, the terminal reports antenna switching capability information corresponding to at least one panel to the network device.

Illustratively, the antenna switching capability information indicates a supporting capability of the terminal for switching between antennas or antenna ports.

The antennas refer to the physical antennas of the terminal, and the antenna ports indicate logical ports used by the terminal for information transmission. The antenna ports may correspond to one or more physical antennas at the same time.

Based on the above description, the supporting capability for switching between antennas or antenna ports includes at least one of the following: supporting a transmit antenna or transmit antenna port switching; supporting a receive antenna or receive antenna port switching; or supporting the transmit antenna or transmit antenna port switching and the receive antenna or receive antenna port switching.

In some examples, the antenna switching capability information is carried in terminal capability information.

The relevant contents of the antennas or the antenna ports, the antenna switching capability information, and the terminal capability information may make reference to the above description, without being repeated here.

Illustratively, in order to achieve information transmission, at least one panel is provided on the terminal, and each panel has corresponding supporting capability for switching between antennas or antenna ports. In this case, the supporting capability for switching between antennas or antenna ports corresponding to each panel may be identical or different.

In an implementation scenario example, the terminal includes a panel, and reports the antenna switching capability information corresponding to the panel to the network device.

In another implementation scenario example, the terminal includes two panels that correspond to different supporting capabilities for switching between antennas or antenna ports, and separately reports the antenna switching capability information corresponding to the two panels to the network device.

In another implementation scenario example, the terminal includes three panels that correspond to the same supporting capability for switching between antennas or antenna ports, and reports the antenna switching capability information corresponding to any one panel to the network device.

At step 420, the network device receives the antenna switching capability information corresponding to at least one panel reported by the terminal.

Illustratively, the antenna switching capability information indicates the supporting capability of the terminal for switching between antennas or antenna ports.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the antenna switching capability information is carried in the terminal capability information.

The relevant contents of the antennas or the antenna ports, the antenna switching capability information, and the terminal capability information may make reference to the above description, without being repeated here.

According to step 420, after receiving the antenna switching capability information corresponding to at least one panel reported by the terminal, the network device may obtain the supporting capability for switching between antennas or antenna ports corresponding to at least one panel according to the information. Therefore, the network device performs a network scheduling, determines the antenna or antenna port switching of the terminal, and feeds it back to the terminal to implement the antenna or antenna port switching corresponding to at least one panel, thereby meeting the transmission requirements.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

In view of the above, in the capability information reporting method and the capability information receiving method provided by the example of the present disclosure, by reporting the antenna switching capability information corresponding to at least one panel to the network device by the terminal, the network device can perform the scheduling based on the antenna switching capability information corresponding to different panels, so as to achieve the antenna or antenna port switching corresponding to different panels.

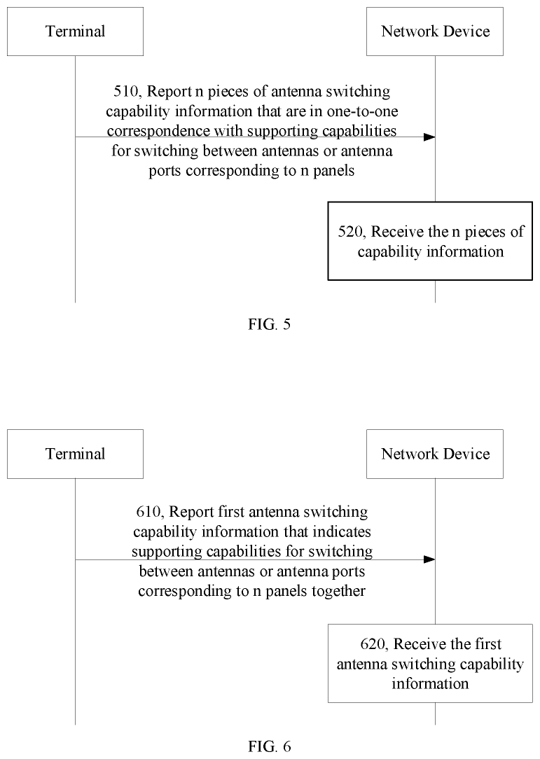

In an implementation scenario example, the terminal includes a plurality of panels. Therefore, there are multiple examples for implementing the capability information transmission method. It takes the terminal including n panels as an example, with n being a positive integer greater than zero. Making reference to FIGS. 5, 6 and 7, illustratively, the examples of the present disclosure provide three capability information transmission method examples, which are described in detail as follows.

FIG. 5 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 510-520.

At step 510, the terminal reports n pieces of antenna switching capability information to the network device.

Illustratively, the n pieces of antenna switching capability information are in one-to-one correspondence with supporting capabilities for switching between antennas or antenna ports corresponding to n panels.

Based on the above description, the supporting capability for switching between antennas or antenna ports includes at least one of the following: supporting a transmit antenna or transmit antenna port switching; supporting a receive antenna or receive antenna port switching; or supporting the transmit antenna or transmit antenna port switching and the receive antenna or receive antenna port switching.

In some examples, the antenna switching capability information is carried in terminal capability information.

The relevant contents of the antennas or the antenna ports, the antenna switching capability information, and the terminal capability information may make reference to the above description, without being repeated here.

Illustratively, the n pieces of antenna switching capability information are reported separately. In this case, the n pieces of antenna switching capability information may be reported simultaneously or not simultaneously, may be reported sequentially or randomly, may be reported partially or fully, which is not limited here.

According to the above description, each panel corresponds to a supporting capability for switching between antennas or antenna ports. The supporting capability for switching between antennas or antenna ports corresponding to each panel may be identical or different.

It takes an example in which n panels includes a first panel and a second panel. Step 510 may be implemented as the step that the terminal reports the antenna switching capability information corresponding to the first panel and the second panel to the network device. In some examples, the supporting capabilities for switching between antennas or antenna ports corresponding to the first panel and the second panel are different.

At step 520, the network device receives the antenna switching capability information corresponding to the n panels reported by the terminal.

Illustratively, the n pieces of antenna switching capability information are in one-to-one correspondence with the supporting capabilities for switching between antennas or antenna ports corresponding to the n panels.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the antenna switching capability information is carried in the terminal capability information.

The relevant contents of the antennas or the antenna ports, the antenna switching capability information, and the terminal capability information may make reference to the above description, without being repeated here.

According to step 520, after receiving the n pieces of antenna switching capability information reported by the terminal, the network device may obtain the supporting capabilities for switching between antennas or antenna ports corresponding to the n panels according to the information. Therefore, the network device performs a network scheduling, determines the antenna or antenna port switching corresponding to the n panels, and feeds it back to the terminal.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

FIG. 6 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 610-620.

At step 610, the terminal reports first antenna switching capability information to the network device.

Illustratively, the first antenna switching capability information indicates the supporting capabilities for switching between antennas or antenna ports corresponding to n panels together.

Based on the above description, the supporting capability for switching between antennas or antenna ports includes at least one of the following: supporting a transmit antenna or transmit antenna port switching; supporting a receive antenna or receive antenna port switching; or supporting the transmit antenna or transmit antenna port switching and the receive antenna or receive antenna port switching.

In some examples, the antenna switching capability information is carried in terminal capability information.

The relevant contents of the antennas or the antenna ports, the antenna switching capability information, and the terminal capability information may make reference to the above description, without being repeated here.

Illustratively, the first antenna switching capability information achieves reporting the supporting capabilities for switching between antennas or antenna ports corresponding to the n panels together. In this case, the supporting capability for switching between antennas or antenna ports corresponding to each panel may be identical or different.

It takes an example in which the n panels include a first panel and a second panel. Step 610 may be implemented as the step that the terminal reports the first antenna switching capability information to the network device. The first antenna switching capability information indicates the supporting capabilities for switching between antennas or antenna ports corresponding to the first panel and the second panel.

At step 620, the network device receives the first antenna switching capability information reported by the terminal.

Illustratively, the first antenna switching capability information indicates the supporting capabilities for switching between antennas or antenna ports corresponding to the n panels together.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the first antenna switching capability information is carried in terminal capability information.

The relevant contents of the antennas or the antenna ports, the antenna switching capability information, and the terminal capability information may make reference to the above description, without being repeated here.

According to step 620, after receiving the first antenna switching capability information reported by the terminal, the network device may obtain the supporting capabilities for switching between antennas or antenna ports corresponding to the n panels according to the information. Therefore, the network device performs a network scheduling, determines the antenna or antenna port switching of the terminal corresponding to the n panels, and feeds it back to the terminal.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

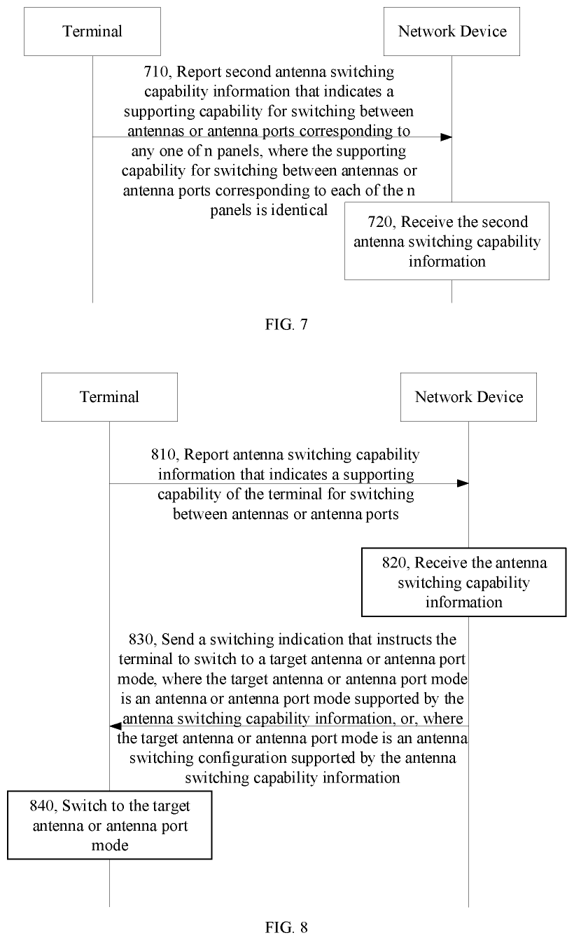

FIG. 7 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 710-720.

At step 710, the terminal reports second antenna switching capability information to the network device.

Illustratively, the second antenna switching capability information indicates a supporting capability for switching between antennas or antenna ports corresponding to any one of n panels, and the supporting capability for switching between antennas or antenna ports corresponding to each of n panels are identical.

Based on the above description, the supporting capability for switching between antennas or antenna ports includes at least one of the following: supporting a transmit antenna or transmit antenna port switching; supporting a receive antenna or receive antenna port switching; or supporting the transmit antenna or transmit antenna port switching and the receive antenna or receive antenna port switching.

In some examples, the antenna switching capability information is carried in terminal capability information.

The relevant contents of the antennas or the antenna ports, the antenna switching capability information, and the terminal capability information may make reference to the above description, without being repeated here.

It takes an example in which the n panels include a first panel and a second panel. Step 710 may be implemented as the step that the terminal reports the second antenna switching capability information to the network device. The second antenna switching capability information indicates the supporting capabilities for switching between antennas or antenna ports corresponding to the first panel and the second panel. In this example, the supporting capabilities for switching between antennas or antenna ports corresponding to the first panel and the second panel are identical.

At step 720, the network device receives the second antenna switching capability information reported by the terminal.

Illustratively, the second antenna switching capability information indicates the supporting capability for switching between antennas or antenna ports corresponding to any one of the n panels, and the supporting capability for switching between antennas or antenna ports corresponding to each of the n panels are identical.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the second antenna switching capability information is carried in the terminal capability information.

The relevant contents of the antennas or the antenna ports, the antenna switching capability information, and the terminal capability information may make reference to the above description, without being repeated here.

According to step 720, after receiving the second antenna switching capability information reported by the terminal, the network device may obtain the supporting capability for switching between antennas or antenna ports corresponding to any one of the n panels according to the information. Since the supporting capability for switching between antennas or antenna ports corresponding to the n panels are identical, when the network device obtains the second antenna switching capability information, it is equivalent to obtain the supporting capabilities for switching between antennas or antenna ports corresponding to all the panels. Therefore, the network device performs a network scheduling, determines the antenna or antenna port switching corresponding to the n panels, and feeds it back to the terminal.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

In view of the above, in the capability information reporting method and the capability information receiving method provided by the example of the present disclosure, by taking the example in which the terminal includes three panels, it provides three implementation examples for transmitting the antenna switching capability information to achieve the antenna or antenna port switching, which is described in detail as follows.

In an implementation scenario example, by reporting n pieces of antenna switching capability information, it achieves that the supporting capabilities for switching between antennas or antenna ports corresponding to the n panels are reported separately.

In an implementation scenario example, by reporting the first antenna switching capability information, it achieves that the supporting capabilities for switching between antennas or antenna ports corresponding to the n panels are reported together.

In an implementation scenario example, in the case where the supporting capability for switching between the antennas or antenna ports corresponding to each of the n panels is identical, the capability information is transmitted by reporting the second antenna switching capability information.

FIG. 8 illustrates a flowchart of a capability information transmission method according to an example of the present disclosure. The example of the present disclosure is described by taking the capability information transmission method applied to the mobile communication system illustrated in FIG. 2 as an example, with the mobile communication system including a terminal and a network device. The capability information transmission method includes the following steps 810-840.

At step 810, the terminal reports antenna switching capability information to the network device.

Illustratively, the antenna switching capability information indicates a supporting capability of the terminal for switching between antennas or antenna ports.

Based on the above description, the supporting capability for switching between antennas or antenna ports includes at least one of the following: supporting a transmit antenna or transmit antenna port switching; supporting a receive antenna or receive antenna port switching; or supporting the transmit antenna or transmit antenna port switching and the receive antenna or receive antenna port switching.

In some examples, the antenna switching capability information is carried in terminal capability information.

The relevant contents of the antennas or the antenna ports, the antenna switching capability information, and the terminal capability information may make reference to the above description, without being repeated here.

Illustratively, step 810 is the same as and makes reference to step 310, without being repeated here.

The specific reporting scheme of the antenna switching capability information may make reference to the examples illustrated in FIGS. 4-7, whose details may make reference to the foregoing description.

At step 820, the network device receives the antenna switching capability information reported by the terminal.

Illustratively, the antenna switching capability information indicates the supporting capability of the terminal for switching between antennas or antenna ports.

Based on the above description, the supporting capability for switching between antennas or antenna ports includes at least one of the following: supporting the transmit antenna or transmit antenna port switching; supporting the receive antenna or receive antenna port switching; or supporting the transmit antenna or transmit antenna port switching and the receive antenna or receive antenna port switching.

In some examples, the antenna switching capability information is carried in the terminal capability information.

The relevant contents of the antennas or the antenna ports, the antenna switching capability information, and the terminal capability information may make reference to the above description, without being repeated here.

Illustratively, step 820 is the same as and may make reference to step 320, without being repeated here.

At step 830, the network device sends a switching indication to the terminal.

Illustratively, the switching indication instructs the terminal to switch to a target antenna or antenna port mode. The target antenna or antenna port mode is an antenna or antenna port mode supported by the antenna switching capability information. Alternatively, the target antenna or antenna port mode is an antenna switching configuration supported by the antenna switching capability information.

The antenna or antenna port mode, or the antenna switching configuration, refers to a usage state of the antennas or the antenna ports determined according to the antenna switching capability information, including but not limited to the usage number of the antennas or the antenna ports and the direction of information transmission. For example, the target antenna or antenna port mode is 2T6R, which is determined according to the antenna switching capability information in step 810 or step 820. In this mode, the usage state of the antennas or the antenna ports is: two transmit antennas or transmit antenna ports are used for uplink transmission, and four receive antennas or receive antenna ports are used for downlink transmission.

Based on step 810 and step 820, the network device can acquire the supporting capability of the terminal for switching between antennas or antenna ports. Subsequently, the network device performs a network scheduling based on the supporting capability reported by the terminal, determines the antenna or antenna port switching of the terminal, and feeds it back to the terminal.

Alternatively or additionally, the switching indication may be determined based on scheduling strategies corresponding to different transmission requirements. The scheduling strategies may be configured according to actual needs, which is not limited here.

At step 840, the terminal is switched to the target antenna or antenna port mode.

Illustratively, the target antenna or antenna port mode is the antenna or antenna port mode supported by the antenna switching capability information. Alternatively, the target antenna or antenna port mode is the antenna switching configuration supported by the antenna switching capability information.

Based on the above description, the antenna or antenna port mode, or the antenna switching configuration, refers to the usage state of the antennas or the antenna ports determined according to the antenna switching capability information, including but not limited to the usage number of the antennas or the antenna ports and the direction of information transmission.

According to step 830, the terminal may obtain the switching indication sent by the network device. Based on the switching indication, the terminal switches its current antenna or antenna port mode to the target antenna or antenna port mode. For example, the target antenna or antenna port mode in the switching indication sent by the network device is 2T6R, and the current antenna or antenna port mode of the terminal is 4T6R. Accordingly, the terminal switches the target antenna or antenna port mode from 4T6R to 2T6R. In this example, for example, the terminal only switches the transmit antennas or the transmit antenna ports.

Illustratively, in the example of the present disclosure, the steps on the terminal side may form an example of a capability information reporting method by itself, and the steps on the network device side may form an example of a capability information receiving method by itself. The specific explanation of the steps of the capability information reporting method and the capability information receiving method may make reference to the above description, without being repeated here.

In view of the above, in the capability information reporting method and the capability information receiving method provided by the example of the present disclosure, by sending the switching indication to the terminal by the network device, the terminal can switch its antenna or antenna port mode in accordance with the switching indication.

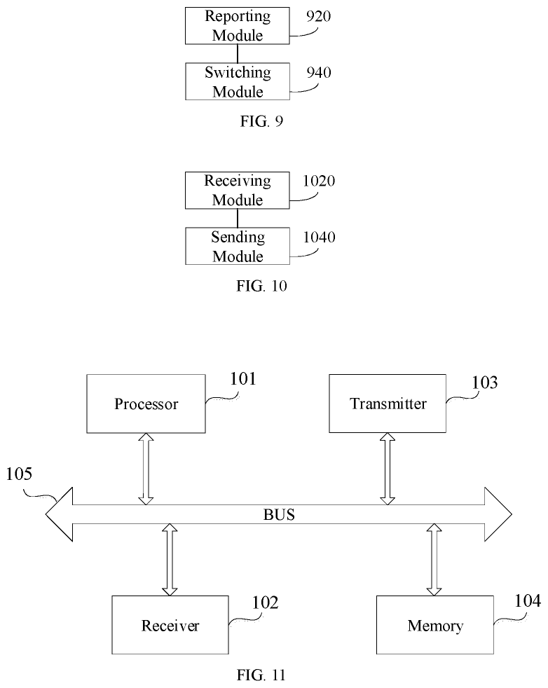

FIG. 9 illustrates a structure block diagram of a capability information reporting apparatus according to an example of the present disclosure. The apparatus may be implemented as a terminal or a part thereof. The apparatus includes a reporting module 920.

The reporting module 920 is configured to report antenna switching capability information. The antenna switching capability information indicates a supporting capability of the terminal for switching between antennas or antenna ports.

In an implementation example, the reporting module 920 is configured for the terminal to report the antenna switching capability information corresponding to at least one panel to a network device.

In an implementation example, the reporting module 920 is configured for the terminal to report n pieces of antenna switching capability information to the network device. The n pieces of antenna switching capability information are in one-to-one correspondence with the supporting capabilities for switching between antennas or antenna ports corresponding to n panels. The n is a positive integer greater than zero.

In an implementation example, the reporting module 920 is configured for the terminal to report first antenna switching capability information to the network device. The first antenna switching capability information indicates the supporting capabilities for switching between antennas or antenna ports corresponding to the n panels together. The n is a positive integer greater than zero.

In an implementation example, the reporting module 920 is configured for the terminal to report second antenna switching capability information to the network device. The second antenna switching capability information indicates the supporting capability for switching between antennas or antenna ports corresponding to any one of the n panels. The supporting capability for switching between antennas or antenna ports corresponding to each of the n panels is identical. The n is a positive integer greater than zero.

In an implementation example, the supporting capability for switching between antennas or antenna ports includes one of the following: supporting a transmit antenna or transmit antenna port switching; supporting a receive antenna or receive antenna port switching; or supporting the transmit antenna or transmit antenna port switching and the receive antenna or receive antenna port switching.

In an implementation example, the antenna switching capability information is carried in terminal capability information.

In an implementation example, the apparatus further includes a switching module 940, configured to switch the terminal to a target antenna or antenna port mode. The target antenna or antenna port mode is an antenna or antenna port mode supported by the antenna switching capability information. Alternatively, the target antenna or antenna port mode is an antenna switching configuration supported by the antenna switching capability information.

FIG. 10 illustrates a structure block diagram of a capability information receiving apparatus according to an example of the present disclosure. The apparatus may be implemented as a network device or a part thereof. The apparatus includes a receiving module 1020.

The receiving module 1020 is configured to receive antenna switching capability information reported by a terminal. The antenna switching capability information indicates a supporting capability of the terminal for switching between antennas or antenna ports.

In an implementation example, the receiving module 1020 is configured for the network device to receive the antenna switching capability information corresponding to at least one panel reported by the terminal.

In an implementation example, the receiving module 1020 is configured for the network device to receive n pieces of capability information reported by the terminal. The n pieces of antenna switching capability information are in one-to-one correspondence with the supporting capabilities for switching between antennas or antenna ports corresponding to n panels. The terminal includes the n panels, and n is a positive integer greater than zero.

In an implementation example, the receiving module 1020 is configured for the network device to receive first antenna switching capability information reported by the terminal. The first antenna switching capability information indicates the supporting capabilities for switching between antennas or antenna ports corresponding to n panels together. The terminal includes the n panels, and n is a positive integer greater than zero.

In an implementation example, the receiving module 1020 is configured for the network device to receive second antenna switching capability information reported by the terminal. The second antenna switching capability information indicates the supporting capability for switching between antennas or antenna ports corresponding to any one of n panels. The supporting capability for switching between antennas or antenna ports corresponding to each of the n panels is identical. The terminal includes the n panels, and n is a positive integer greater than zero.

In an implementation example, the supporting capability for switching between antennas or antenna ports includes one of the following: supporting a transmit antenna or transmit antenna port switching; supporting a receive antenna or receive antenna port switching; or supporting the transmit antenna or transmit antenna port switching and the receive antenna or receive antenna port switching.

In an implementation example, the antenna switching capability information is carried in terminal capability information.

In an implementation example, the apparatus further includes a sending module 1040, configured for the network device to send a switching indication to the terminal. The switching indication instructs the terminal to switch to a target antenna or antenna port mode. The target antenna or antenna port mode is an antenna or antenna port mode supported by the antenna switching capability information. Alternatively, the target antenna or antenna port mode is an antenna switching configuration supported by the antenna switching capability information.

FIG. 11 illustrates a schematic structure diagram of a communication device (a terminal or a network device) according to an example of the present disclosure. The communication device includes: a processor 101, a receiver 102, a transmitter 103, a memory 104 and a bus 105.

The processor 101 includes one or more processing cores, and the processor 101 performs various functional applications and information processing by running software programs and modules.

The receiver 102 and the transmitter 103 may be implemented as a communication component, which may be a communication chip.

The memory 104 is connected to the processor 101 through the bus 105.

The memory 104 may be configured to store at least one instruction, and the processor 101 is configured to execute the at least one instruction, so as to implement each step of the capability information transmitting methods as described above, or each step of the capability information receiving methods as described above step.

In addition, the memory 104 may be implemented by any type of volatile or non-volatile storage device or a combination thereof. The volatile or non-volatile storage device includes but not limited to: a magnetic disk or an optical disk, an electrically erasable programmable read-only memory (EEPROM), an erasable and programmable read-only memory (EPROM), a static random access memory (SRAM), a read-only memory (ROM), a magnetic memory, a flash memory, or a programmable read-only memory (PROM).

As illustrated in FIG. 11, the present disclosure provides a terminal. The terminal includes the processor 101 and the memory 104. The memory 104 stores at least one piece of program code, and the program code is loaded and executed by the processor 101 to implement the capability information reporting methods as described above.

As illustrated in FIG. 11, the present disclosure provides a network device. The network device includes the processor 101 and the memory 104. The memory 104 stores at least one piece of program code, and the program code is loaded and executed by the processor 101 to implement the capability information receiving methods as described above.

According to an example, a computer-readable storage medium is provided. The readable storage medium stores at least one piece of program code. The program code is loaded and executed by one or more processors to implement the capability information reporting methods as described above or the capability information receiving methods as described above.

According to an example, a computer program product or a computer program is provided. The computer program product or the computer program includes computer instructions stored in a computer-readable storage medium. The computer instructions are read from the computer-readable storage medium by one or more processors of a computer device and are executed by the one or more processors, so that the computer device performs the capability information reporting methods as described above or the capability information receiving methods as described above.

According to one aspect of the present disclosure, a chip is provided, including a programmable logic circuit or a program. The chip is configured to implement the capability information reporting methods as described above or the capability information receiving methods as described above.

The technical solutions provided by the examples of the present disclosure include at least the following beneficial effects.

By reporting antenna switching capability information to a network device by a terminal, the network device can schedule a terminal-level antenna switching according to a supporting capability of the terminal for switching between antennas or antenna ports.

The above are only some alternative or additional examples of the present disclosure, and are not intended to limit the present disclosure. Any modifications, equivalent replacements, improvements, etc. made within the spirit and principles of the present disclosure shall be included in the protection scope of the present disclosure.

1. A capability information reporting method, comprising:
reporting, by a terminal, antenna switching capability information to a network device;
wherein the antenna switching capability information indicates a supporting capability of the terminal for switching between antennas or antenna ports.

2. The method according to claim 1, wherein reporting, by the terminal, the antenna switching capability information to the network device comprises:
reporting, by the terminal, the antenna switching capability information corresponding to at least one panel to the network device.

3. The method according to claim 2, wherein the terminal comprises n panels, and reporting, by the terminal, the antenna switching capability information corresponding to at least one panel to the network device comprises:
reporting, by the terminal, n pieces of antenna switching capability information to the network device, wherein the n pieces of antenna switching capability information are in one-to-one correspondence with supporting capabilities for switching between antennas or antenna ports corresponding to the n panels, and wherein n is a positive integer greater than zero.

4. The method according to claim 2, wherein the terminal comprises n panels, and reporting, by the terminal, the antenna switching capability information corresponding to at least one panel to the network device comprises:
reporting, by the terminal, first antenna switching capability information to the network device, wherein the first antenna switching capability information indicates supporting capabilities for switching between antennas or antenna ports corresponding to the n panels together, and wherein n is a positive integer greater than zero.

5. The method according to claim 2, wherein the terminal comprises n panels, and reporting, by the terminal, the antenna switching capability information corresponding to at least one panel to the network device comprises:
reporting, by the terminal, second antenna switching capability information to the network device, wherein the second antenna switching capability information indicates supporting capability for switching between antennas or antenna ports corresponding to any one of the n panels, wherein the supporting capability for switching between antennas or antenna ports corresponding to each of the n panels is identical, and wherein n is a positive integer greater than zero.

6. The method according to claim 1, wherein the supporting capability for switching between antennas or antenna ports comprises one of:
supporting a transmit antenna or transmit antenna port switching;
supporting a receive antenna or receive antenna port switching; and
supporting the transmit antenna or transmit antenna port switching and the receive antenna or receive antenna port switching.

7. The method according to claim 1, wherein the antenna switching capability information is carried in terminal capability information.

8. The method according to claim 1, further comprising:
switching, by the terminal, to a target antenna or antenna port mode;
wherein the target antenna or antenna port mode is an antenna or antenna port mode supported by the antenna switching capability information, or,
wherein the target antenna or antenna port mode is an antenna switching configuration supported by the antenna switching capability information.

9. A capability information receiving method, comprising:
receiving, by a network device, antenna switching capability information reported by a terminal;
wherein the antenna switching capability information indicates a supporting capability of the terminal for switching between antennas or antenna ports.

10. The method according to claim 9, wherein receiving, by the network device, the antenna switching capability information reported by the terminal comprises:
receiving, by the network device, the antenna switching capability information corresponding to at least one panel reported by the terminal.

11. The method according to claim 10, wherein receiving, by the network device, the antenna switching capability information corresponding to at least one panel reported by the terminal comprises:
receiving, by the network device, n pieces of antenna switching capability information reported by the terminal, wherein the n pieces of antenna switching capability information are in one-to-one correspondence with supporting capabilities for switching between antennas or antenna ports corresponding to n panels, wherein the terminal comprises the n panels, and wherein n is a positive integer greater than zero.

12. The method according to claim 10, wherein receiving, by the network device, the antenna switching capability information corresponding to at least one panel reported by the terminal comprises:
receiving, by the network device, first antenna switching capability information reported by the terminal, wherein the first antenna switching capability information indicates supporting capabilities for switching between antennas or antenna ports corresponding to n panels together, wherein the terminal comprises the n panels, and wherein n is a positive integer greater than zero.

13. The method according to claim 10, wherein receiving, by the network device, the antenna switching capability information corresponding to at least one panel reported by the terminal comprises:
receiving, by the network device, second antenna switching capability information reported by the terminal, wherein the second antenna switching capability information indicates supporting capability for switching between antennas or antenna ports corresponding to any one of n panels, wherein the supporting capability for switching between antennas or antenna ports corresponding to each of the n panels is identical, wherein the terminal comprises the n panels, and wherein n is a positive integer greater than zero.

14. The method according to claim 9, wherein the supporting capability for switching between antennas or antenna ports comprises one of:
supporting a transmit antenna or transmit antenna port switching;
supporting a receive antenna or receive antenna port switching; and
supporting the transmit antenna or transmit antenna port switching and the receive antenna or receive antenna port switching.

15. The method according to claim 9, wherein the antenna switching capability information is carried in terminal capability information.

16. The method according to claim 9, further comprising:
sending, by the network device, a switching indication to the terminal, wherein the switching indication instructs the terminal to switch to a target antenna or antenna port mode;
wherein the target antenna or antenna port mode is an antenna or antenna port mode supported by the antenna switching capability information, or
wherein the target antenna or antenna port mode is an antenna switching configuration supported by the antenna switching capability information.

17.-18. (canceled)

19. A terminal, comprising:
one or more processors, and
one or more memories that store at least one piece of program code,
wherein the program code is loaded and executed by the one or more processors to implement:
reporting antenna switching capability information to a network device;
wherein the antenna switching capability information indicates a supporting capability of the terminal for switching between antennas or antenna ports.

20. A network device, comprising:
one or more processors, and
one or more memories that store at least one piece of program code,
wherein the program code is loaded and executed by the one or more processors to implement the capability information receiving method according to claim 9.

21. A computer-readable storage medium, storing at least one piece of program code, wherein the program code is loaded and executed by one or more processors to implement the capability information reporting method according to claim 1.

22. A computer-readable storage medium, storing at least one piece of program code, wherein the program code is loaded and executed by one or more processors to implement the capability information receiving method according to claim 9.
